(19) United States
(12) Patent Application Publication
(10) Pub. No.: US 2009/0316960 A1
(43) Pub. Date: Dec. 24, 2009

(54) MOBILE ELECTRONIC DEVICE SECURITY PROTECTING SYSTEM AND METHOD

(75) Inventor: SHIH-HAO WANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/463,412

(22) Filed: May 10, 2009

(30) Foreign Application Priority Data
Jun. 23, 2008 (CN) 200810302274.0

(51) Int. Cl. G06F 7/04; G06K 9/00

(52) U.S. Cl. 382/115; 340/5.81

(57) ABSTRACT

A system and method of protecting security of a mobile electronic includes capturing one or more images by a camera of the mobile electronic device and storing the one or more images into a memory system of the mobile electronic device. The system and method further includes converting each of the one or more captured images into an intensity image in response to the determination that the number of the one or more captured images are equal to a predetermined number. Furthermore, the system and method includes comparing each intensity image with the user-predetermined image, and displaying unlock success or failure information according to the comparison.

### BACKGROUND

1. Technical Field

Embodiments of the present disclosure are related to electronic device management systems and methods, and particularly to a mobile electronic device security protecting system and method.

2. Description of Related Art

A mobile electronic device is a pocket-sized computing device, which includes a small visual display for output and a miniature keyboard or touch screen for input. The mobile electronic devices can store various kinds of private information (e.g., personal data, phone lists, message records, stock quotes information and call histories, etc). One method for ensuring information security of a mobile electronic device is setting a password by a user. However, if the password for the mobile electronic device is leaked, the mobile electronic device may be unlocked by others.

Therefore, there is a need for a system and method to overcome the aforementioned problem.

### BRIEF DESCRIPTION OF THE DRAWINGS

FIG. 1 is a block diagram of one embodiment of a system for protecting security of a mobile electronic device.

FIG. 2 is a flowchart of one embodiment of a method of protecting security of a mobile electronic device.

FIG. 3 illustrates one embodiment of a user-predetermined image.

### DETAILED DESCRIPTION

All of the processes described below may be embodied in, and fully automated via, function modules executed by one or more general purpose processors of a mobile electronic device. Some or all of the methods may alternatively be embodied in specialized hardware. The function modules may be stored in any type of computer-readable medium or other computer storage device.

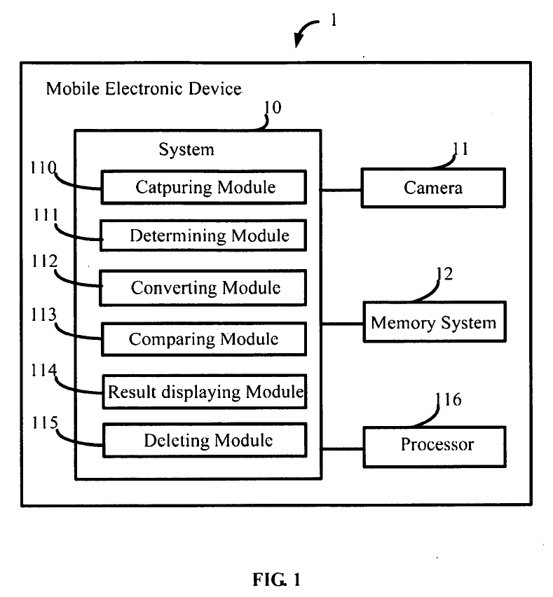

FIG. 1 is a block diagram of one embodiment of a system 10 for protecting security of a mobile electronic device 1. In one embodiment, the mobile electronic device 1 includes a camera 11, a memory system 12, and a display device (not shown in FIG. 1). The camera 11 captures images of objects, such as a person. The display device shows unlock success or unlock failure information of an unlocking of the mobile electronic device 1. It may be understood that, in this embodiment, the camera 11 is still usable even if the mobile electronic device 1 is in a locked mode.

The memory system 12 pre-stores a user-predetermined image and an identification standard. In one embodiment, the user-predetermined image may be, but not limited to, a facial image of the user. The identification standard defines a similarity degree between an intensity image and the user-predetermined image. For example, the similarity degree may be set at 60%. The memory system 12 may be an internal memory system card or an external memory system card. The external memory system card may include a smart media card (SMC), a secure digital card (SDC), a compact flash card (CFC), a multi media card (MMC), a memory system stick (MS), an extreme digital card (XDC), and a trans flash card (TFC). Depending on the embodiment, the mobile electronic device 1 may be a mobile phone, a personal digital assistant (PDA), a handheld game player, or a digital camera, among other portable electronic devices with an image capturing function.

The system 10 comprises a plurality of functional modules for determining if images captured by the camera 11 satisfy the identification standard, so as to unlock the mobile electronic device 1. In one embodiment, the system 10 includes a capturing module 110, a determining module 111, a converting module 112, a comparing module 113, a result displaying module 114, and a deleting module 115. The modules 110-115 may be stored in the memory system 12 and comprise one or more computerized operations that are executable by a processor 116.

The capturing module 110 is operable to capture one or more images by the camera 11 of the mobile electronic device 1, and store the one or more captured images into the memory system 12 of the mobile electronic device 1.

The determining module 111 is operable to determine if the number of the one or more captured images is equal to a predetermined number.

The converting module 112 is operable to convert each of the one or more captured images into an intensity image in response to a determination that the number of the captured images is equal to the predetermined number. In one embodiment, the intensity image is a black and white image.

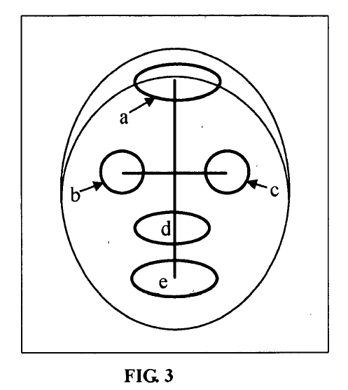

The comparing module 113 is operable to compare each intensity image with the user-predetermined image, so as to determine if each intensity image satisfies the predetermined identification standard, such as the similarity degree of 60%. In one embodiment, if the similarity degree between each intensity image and the user-predetermined image is more than or equal to 60%, the intensity image is regarded as a matching image of the user-predetermined image. The comparing module 113 compares each intensity image with the user-predetermined image by a method of feature point detection. Further details of how to compare the intensity image with the user-predetermined image are described with respect to FIG. 3.

The result displaying module 114 is operable to display unlock success or failure information according to the comparison. In one embodiment, assuming that there are two intensity images A, B and a user-predetermined image D, if the similarity degree between A and D is more than or equal to 60%, and the similarity degree between B and D is more than or equal to 60%, then the result displaying module 114 displays unlock success information on the display device of the mobile electronic device 1. Otherwise the result displaying module 114 displays unlock failure information.

The deleting module 115 is operable to delete the intensity image from the memory system 12 of the mobile electronic device 1.

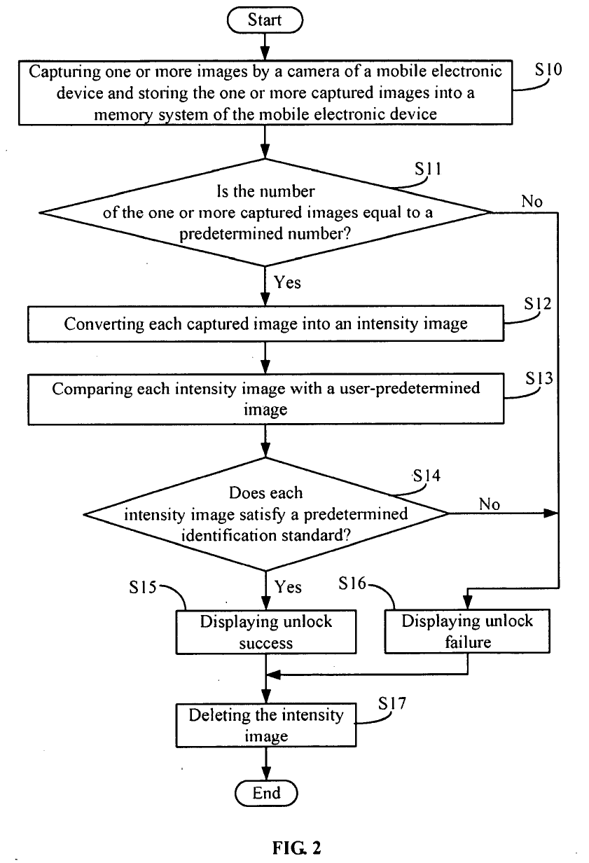

FIG. 2 is a flowchart of one embodiment of a method of protecting security of a mobile electronic device 1. Depending on the embodiment, additional blocks may be added, while others deleted, and the blocks may also be executed in a different order than described.

In block S10, the capturing module 110 captures one or more images by the camera 11 of the mobile electronic device 1 and stores the one or more images into the memory system 12 of the mobile electronic device 1.

In block S11, the determining module 111 determines if the number of the one or more captured images is equal to a predetermined number. For example, assuming that the predetermined number is three, if the number of the one or more captured images is also three, then the procedure turns to block S12. Otherwise, the procedure turns to block S16.

In block S12, the converting module 112 converts each of the one or more captured images into an intensity image. As mentioned above, the intensity image is a black and white image.

In block S13, the comparing module 113 compares each intensity image with the user-predetermined image, so as to determine if each intensity image satisfies the predetermined identification standard, such as the similarity degree of 60%. As mentioned above, if the similarity degree between each intensity image and the user-predetermined image is more than or equal to 60%, the intensity image is regarded as a resembling image with the user-predetermined image. The comparing module 113 compares the intensity image with the user-predetermined image by a method of feature point detection. A detailed description is as follows. As shown in FIG. 3, illustrating one embodiment of facial features of the user-predetermined image denoted as circles a, b, c, d and e. In FIG. 3, the circles a, b, c, d and e respectively denote the hair, the eyes, the nose, the mouth of the user. Assuming that one of the intensity images is A, the comparing module 113 extracts facial features, such as the hair, the eyes, the nose, the mouth, from the intensity image A, then the comparing module 113 compares the relative sizes and relative locations of the hair, the eyes, the nose, the mouth in the intensity image A with sizes and locations of the hair, the eyes, the nose, the mouth of the user-predetermined image respectively. If similarity degree between each facial feature of the intensity image and a corresponding facial feature of the user-predetermined image is more than 60%, then the intensity A is regarded as a resembling image with the user-predetermined image.

In block S14, the comparing module 113 determines if the intensity image satisfies the predetermined identification standard according to comparison. As mentioned above, the comparing module 114 determines each intensity image satisfies the predetermined identification standard, if similarity degree between each intensity image and the user-predetermined image is more than or equal to 60%, then the procedure goes to block S 15. Otherwise, the procedure turns to block S 16.

In block S15, the result displaying module 114 displays unlock success information on the display device of the mobile electronic device 1 in response to the determination that each intensity image satisfies the predetermined identification standard. As mentioned above, assuming that there are two intensity images A, B and a user-predetermined image D, if the similarity degree between A and D is more than or equal to 60%, and the similarity degree between B and D is more than or equal to 60%, then result displaying module 114 displays unlock success information.

In block S16, the result displaying module 115 displays unlock failure information on the display in response to the determination that one of the intensity images does not satisfy the predetermined identification standard. As mentioned above, assuming that there are two intensity images A, B and a user-predetermined image D, if the similarity degree between A and D is less than 60%, or the similarity degree between B and D is less than 60%, then result displaying module 114 displays unlock failure information.

In block S17, the deleting module 115 deletes the intensity image from the memory system 12 of the mobile electronic device 1. As mentioned above, the deleting module 115 deletes the intensity image A and B from the memory system 12.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A security protection system for a mobile electronic device, the mobile electronic device comprising a memory system storing a plurality of programs and a processor that executes one or more operations for the plurality of programs, the programs comprising:
a capturing module operable to capture one or more images by a camera of the mobile electronic device, and store the one or more images into the memory system of the mobile electronic device;
a determining module operable to determine if the number of the one or more captured images is equal to a predetermined number;
a converting module operable to convert each of the one or more captured images into an intensity image, in response to a determination that the number of the one or more captured images is equal to the predetermined number;
a comparing module operable to compare each intensity image with a user-predetermined image pre-stored in the memory system, so as to determine if each intensity image satisfies a predetermined identification standard; and
a result displaying module operable to display unlock success or failure information on a display device of the mobile electronic device according to the comparison.

2. The computing system of claim 1, wherein each intensity image is a black and white image.

3. The computing system of claim 1, wherein the predetermined identification standard defines a similarity degree between the intensity image and the user-predetermined image.

4. The computing system of claim 1, further comprising a deleting module to delete the intensity image from the memory system.

5. The computing system of claim 1, wherein the mobile electronic device is selected from the group consisting of a mobile phone, a personal digital assistant (PDA), a handheld game player, and a digital camera.

6. The computing system of claim 1, wherein the memory system is selected from the group consisting of a smart media card (SMC), a secure digital card (SDC), a compact flash card (CFC), a multi media card (MMC), a memory system stick (MS), an extreme digital card (XDC), and a trans flash card (TFC).

7. A computer-implemented method of protecting security of a mobile electronic device, the method comprising:
capturing one or more images by a camera of the mobile electronic device, and storing the one or more images into a memory system of the mobile electronic device;
determining if the number of the one or more captured images is equal to a predetermined number;
converting each of the one or more captured images into an intensity image, in response to a determination that the number of the one or more captured images is equal to the predetermined number;
comparing each intensity image with a user-predetermined image pre-stored in the memory system, so as to determine if each intensity image satisfies a predetermined identification standard; and
displaying unlock success or failure information on a display device of the mobile electronic device according to the comparison.

8. The method of claim 7, wherein each the intensity image is a black and white image.

9. The method of claim 7, wherein the predetermined identification standard defines a similarity degree between the intensity image and the user-predetermined image.

10. The method of claim 7, further comprising:
deleting the intensity image from the memory system.

11. The method of claim 7, wherein the mobile electronic device is selected from the group consisting of a mobile phone, a personal digital assistant (PDA), a handheld game player, and a digital camera.

12. The method of claim 7, wherein the memory system is selected from the group consisting of a smart media card (SMC), a secure digital card (SDC), a compact flash card (CFC), a multi media card (MMC), a memory system stick (MS), an extreme digital card (XDC), and a trans flash card (TFC).

13. A storage medium having stored thereon instructions that, when executed by a mobile electronic device, causes the mobile electronic device to perform a method of protecting security of a mobile electronic device, the method comprising:
capturing one or more images by a camera of the mobile electronic device, and storing the one or more images into a memory system of the mobile electronic device;
determining if the number of the one or more captured images is equal to a predetermined number;
converting each of the one or more captured images into an intensity image, in response to a determination that the number of the one or more captured images is equal to the predetermined number;
comparing each intensity image with a user-predetermined image pre-stored in the memory system, so as to determine if each intensity image satisfies a predetermined identification standard; and
displaying unlock success or failure information on a display device of the mobile electronic device according to the comparison.

14. The medium of claim 13, wherein each the intensity image is a black and white image.

15. The medium of claim 13, wherein the predetermined identification standard defines a similarity degree between the intensity image and the user-predetermined image.

16. The medium of claim 13, wherein the method further comprising:
deleting the intensity image from the memory system.

17. The medium of claim 13, wherein the mobile electronic device is selected from the group consisting of a mobile phone, a personal digital assistant (PDA), a handheld game player, and a digital camera.

18. The medium of claim 13, wherein the memory system is selected from the group consisting of a smart media card (SMC), a secure digital card (SDC), a compact flash card (CFC), a multi media card (MMC), a memory system stick (MS), an extreme digital card (XDC), and a trans flash card (TFC).
